(19) United States
(12) Patent Application Publication
(10) Pub. No.: US 2014/0365961 A1
(43) Pub. Date: Dec. 11, 2014

(54) UNIFIED WORKLIST

(71) Applicant: Microsoft Corporation, Redmond, WA (US)

(72) Inventors: Todd Lefor, Fargo, ND (US); Michael M. Santos, Seattle, WA (US); Karl Tolgu, Seattle, WA (US)

(21) Appl. No.: 13/912,184

(22) Filed: Jun. 6, 2013

(51) Int. Cl. G06F 3/0482

(52) U.S. Cl. CPC G06F 3/0482
USPC 715/810

(57) ABSTRACT

A notification system receives notifications from a plurality of different components within a business system. The notification system aggregates notifications for a given user, from the plurality of different components in the business system. The notification system displays the aggregated list of notifications for user interaction.

### BACKGROUND

Computer systems are currently in wide use. Such systems often generate messages and various notifications for users. However, in order to view the notifications and messages, it can be quite cumbersome.

By way of example, some computers systems include business systems, such as customer relations management (CRM) systems, enterprise resource planning (ERP) systems, line-of-business (LOB) systems, etc. These types of systems often have many different subsystems, applications, or components. For instance, a business system may have a general ledger application (or component), an inventory application (or component), an alert system, a workflow system, and other items. Each of these items may generate messages, notifications, alerts, etc., that are to be viewed by a given user.

However, in order to view these notifications, the user often has to traverse the business system to the corresponding item, and then open that item and hunt for notifications, alerts, messages, etc. that were generated by the item for the user. By way of example, if the user is to receive notifications from the general ledger component, the user often needs to navigate within the business system to the general ledger application, open that application, then traverse the application to look for notifications, and then act on them.

The same has been true of performing tasks within a business system. For instance, it may be a user's responsibility to approve certain requisitions in performing project management. In order to do that, the user often needs to log into the business system, or otherwise gain access to the business system, and then traverse the system to the requisitions component and open the requisitions component. The user then often needs to traverse within the requisitions component to a purchase requisition approval subcomponent and then sort the purchase requisitions to view those that the user is to approve. If the user was also tasked with approving expense reports, the user often needs to engage in the same type of hunting behavior within the business system to identify expense reports that the user can approve.

It can be seen from this example that, in order for a user to view the notifications, and messages, and to even perform tasks within a business system, it can be difficult. The problem is exacerbated when the user is to receive notifications or task assignments from a plurality of different items (such as applications, components, modules, subcomponents, etc.) within the business system. Attempting to locate all of the various notifications, messages, tasks, etc. that the user is to view, can be time consuming, cumbersome, and error prone. It can be difficult for the user to even know whether he or she has seen all of the items that he or she is intended to see.

The discussion above is merely provided for general background information and is not intended to be used as an aid in determining the scope of the claimed subject matter.

### SUMMARY

A notification system receives notifications from a plurality of different components within a business system. The notification system aggregates notifications for a given user, from the plurality of different components in the business system. The notification system displays the aggregated list of notifications for user interaction.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative business system.

FIG. 2 is a flow diagram illustrating one embodiment of the business system shown in FIG. 1 in generating notifications.

FIGS. 3A-3E show illustrative user interface displays.

FIG. 4 shows one embodiment of the business system shown in FIG. 1 in various architectures.

FIGS. 5-10 show various mobile devices.

FIG. 11 shows a block diagram of one embodiment of a computing environment.

### DETAILED DESCRIPTION

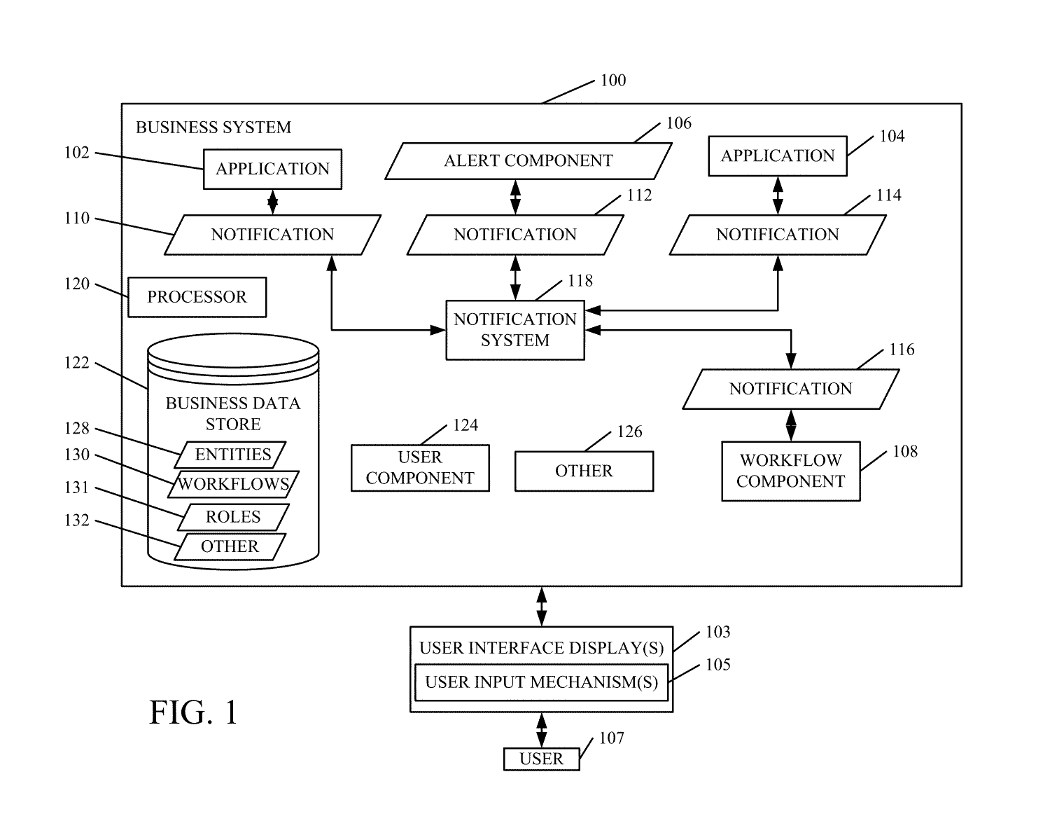

FIG. 1 is a block diagram of one embodiment of a business system 100. Business system 100 can be an ERP system, a CRM system, an LOB system or another business system. Business system 100 illustratively includes a plurality of applications 102 and 104 as well as an alert component 106 and a workflow component 108. Components 102-108 illustratively provide notifications 110, 112, 114 and 116, respectively, to notification system 118. FIG. 1 also shows that business system 100 includes processor 120 and business data store 122, along with user interface component 124. Of course, it will be appreciated that business system 100 can include other components 126 as well.

Business system 100 is shown in FIG. 1 as generating user interface displays 103 with user input mechanisms 105 for interaction by user 107. User interface component 124 can, either itself, or under the control of other items in business system 100, generate user interface displays 103. User interface displays 103 can be generated and provided to a plurality of different users, although only a single user 107 is shown.

User 107 illustratively interacts with user input mechanisms 105 on user interface displays 103 in order to manipulate and control business system 100. User input mechanisms 105 can take a wide variety of different forms, such as icons, links, dropdown menus, buttons, lists, text boxes, check boxes, etc. In addition, user input mechanisms 105 can be actuated in a variety of different ways. For example, they can be actuated using a point and click device (such as a mouse or track ball). In addition, where the display device displays user interface displays 103 on a touch sensitive screen, user input mechanisms 105 can be actuated using touch gestures (such as with a stylus, a user's finger, etc.). Further, where the business system 100, or the computing device that generates displays 103 includes speech recognition components, then user input mechanisms 105 can be actuated using voice commands as well.

Processor 120 is illustratively a computer processor with associated memory and timing circuitry (not separately shown). It is a functional part of business system 100 and facilitates the functionality of applications, components, and other items in business system 100. Business data store 122 illustratively includes entities 128, workflows 130 and can also include other business records or other information 132. Entities 128 illustratively include business data records that describe various items. For instance, entities 128 can include vendor entities that describe vendors, customer entities that describe customers, quote or proposal entities that describe quotes or proposals, business opportunity entities that describe business opportunities, etc. Workflows 130 can be called by applications 102 and 104, and are illustratively executed by workflow component 108 to perform workflows in order to conduct business operations. In addition, they can be executed to allow user 107 to perform tasks or activities within business system 100, in the performance of the duties of user 107.

Each user can illustratively be assigned a role 131. The roles 131 generally define the tasks or activities performed by a given user. For instance, if a user is assigned a human resources role, that user will illustratively have access to human resources records and workflows in order to perform human resources tasks (such as payroll distributions, benefit enrollment, etc.). If the user 107 is assigned an account manager role, then user 107 will illustratively have access to data and workflows in business system 100 in order to perform account management tasks and activities. These are given by way of example only, and other roles can be assigned as well. In addition, a user may illustratively have multiple roles.

Business data store 122 is shown as a single data store, and is local to business system 100. It should be noted, however, that business data store 122 can actually be comprised of multiple different data stores. All of the data stores can be local to business system 100 or remote from business system 100. In addition, some can be local while others are remote.

It will also be noted that FIG. 1 shows a plurality of different blocks. Each block corresponds to a set of functionality or a component or subcomponent of business system 100. It should be noted that the blocks can be combined into fewer blocks, or the functionality can be separated into additional blocks as well. Those blocks that are shown in FIG. 1 are shown for the sake of example only.

Each application 102 and 104 can perform different operations. For example, application 102 may illustratively be a general ledger application that runs the general ledger portion of business system 100. In doing so, it may generate notifications 110 and provide them to notification system 118. Application 104 may, for example, be an inventory application that runs inventory control operations for business system 100. In doing so, it may illustratively generate notifications 114 and provide them to notification system 118.

Alert component 106 can illustratively monitor various applications, processes, workflows, etc. and generate alert notifications 112. The alert notifications can be any of a wide variety of different types of alerts (such as an alert indicating that a particular inventory item is running low, an alert that indicates an unauthorized access to business system 100, an alert indicating that a batch processing run has failed or encountered problems, etc.).

Before describing the overall operation of business system 100 in more detail, a brief discussion of the operation of notification system 118 will be provided, to enhance understanding. Notification system 118 illustratively receives notifications 110, 112, 114 and 116 from the corresponding items in business system 100. Notification system 118 illustratively aggregates the notifications based on the users who are intended to receive the notifications. For example, it may be that user 107 is in an administrative role. It may also be that application 102 is an administrative application. In that case, user 107 may register to receive (or the role of user 107 can be set up to receive) notifications from application 102 as well as specific alerts from alert component 106, and specific workflow notifications from workflow component 108. Notification system 118 will thus aggregate all of the notifications from application 102, the specified alert notifications from alert component 106, and the specified workflow notifications 116 from workflow component 108, into a list of notifications corresponding to user 107. Then, when user 107 requests to see the notifications, notification system 118 generates a display of the notifications on user interface displays 103. Of course, it will be noted that some notifications can be automatically displayed for user 107, regardless of whether they are requested by user 107. However, the present discussion proceeds with respect to the user 107 requesting display of the notifications, but this is described by way of example only. The user can take a variety of different actions relative to any given notification.

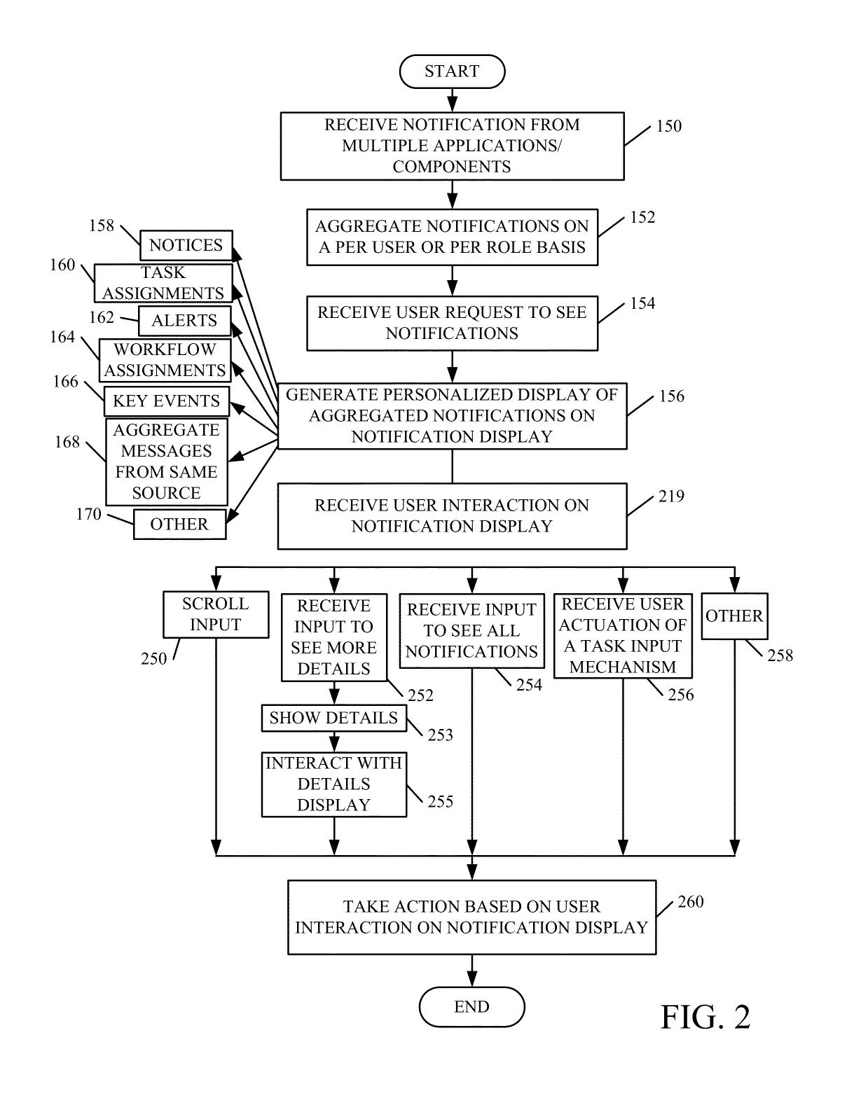

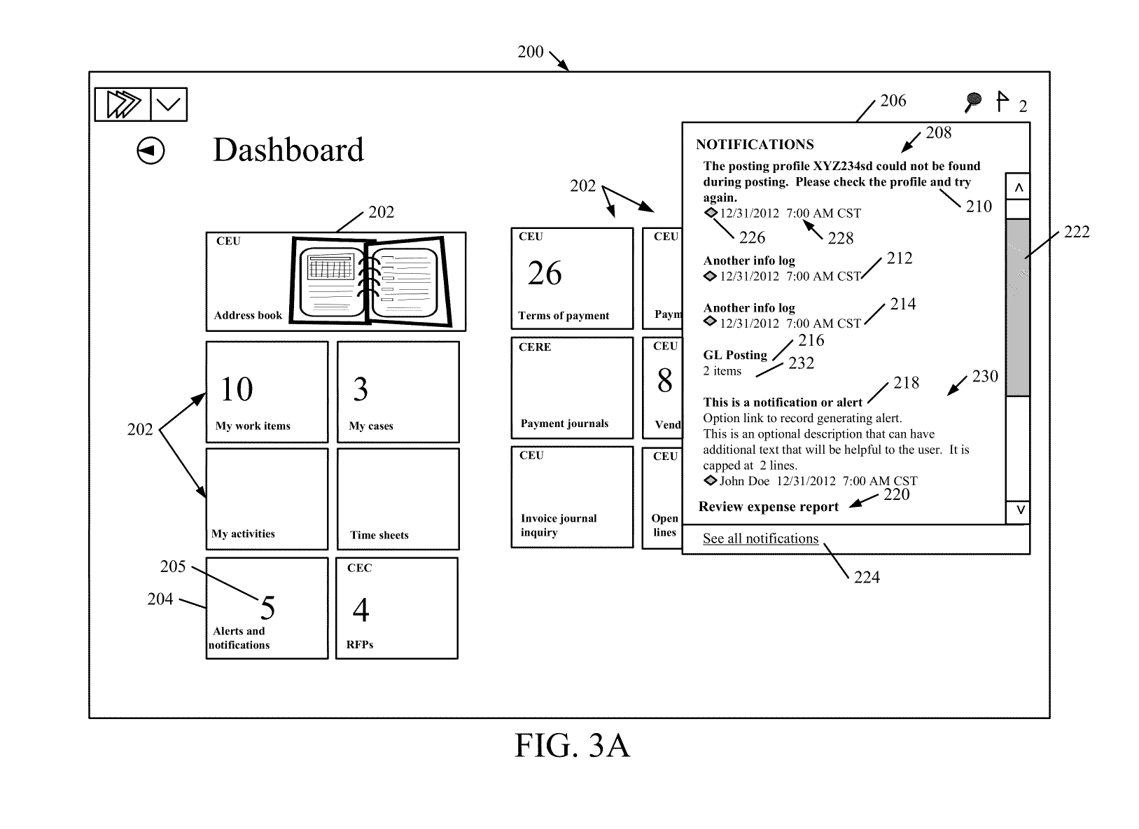

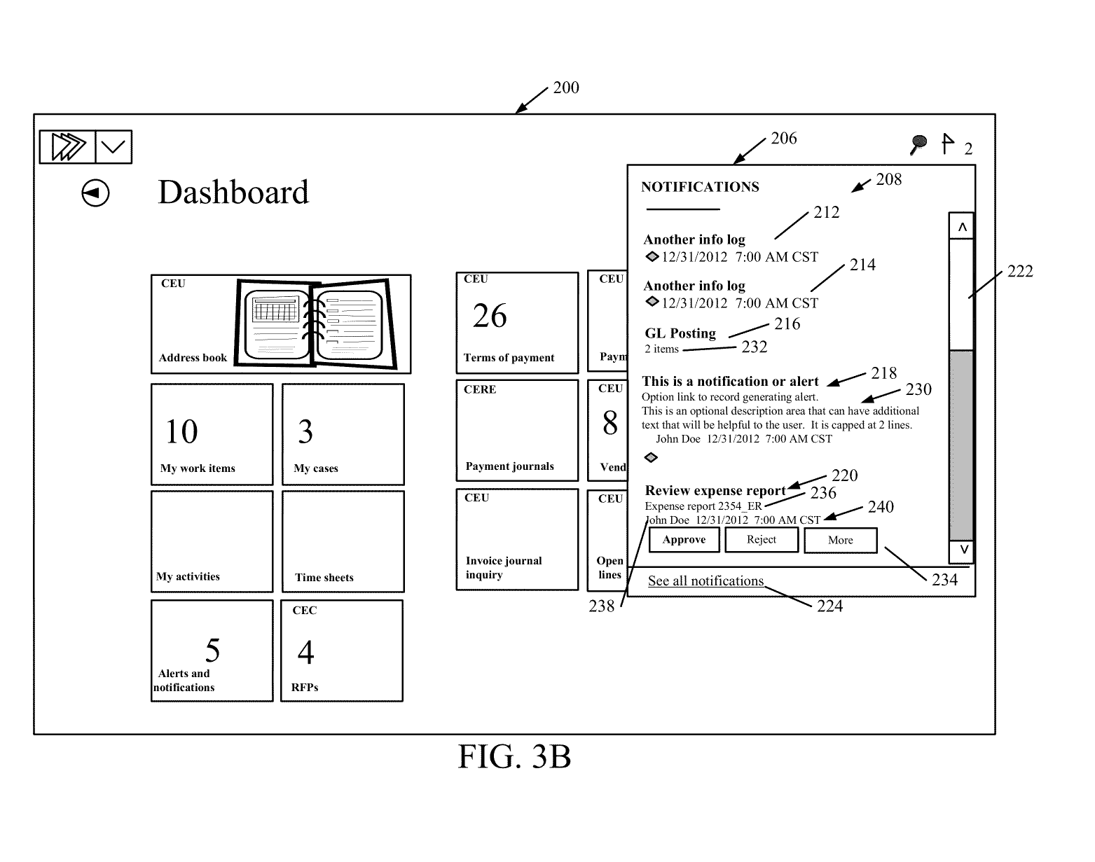

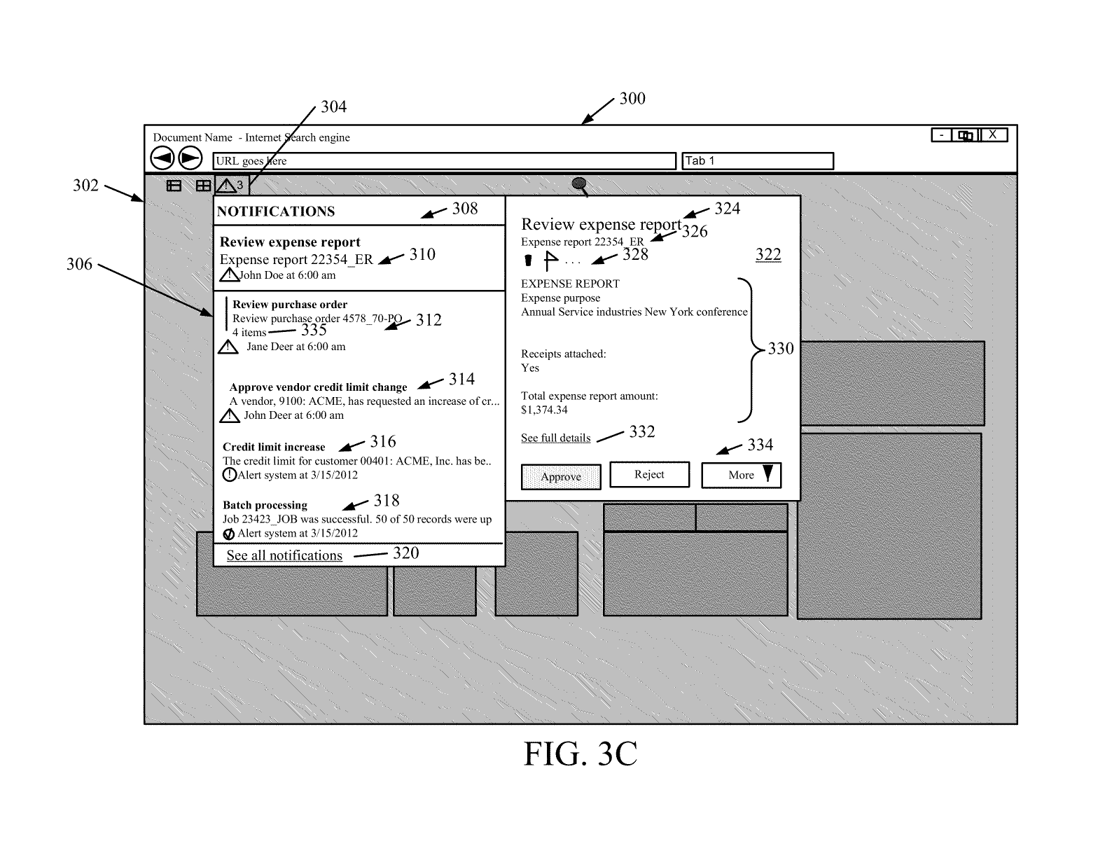

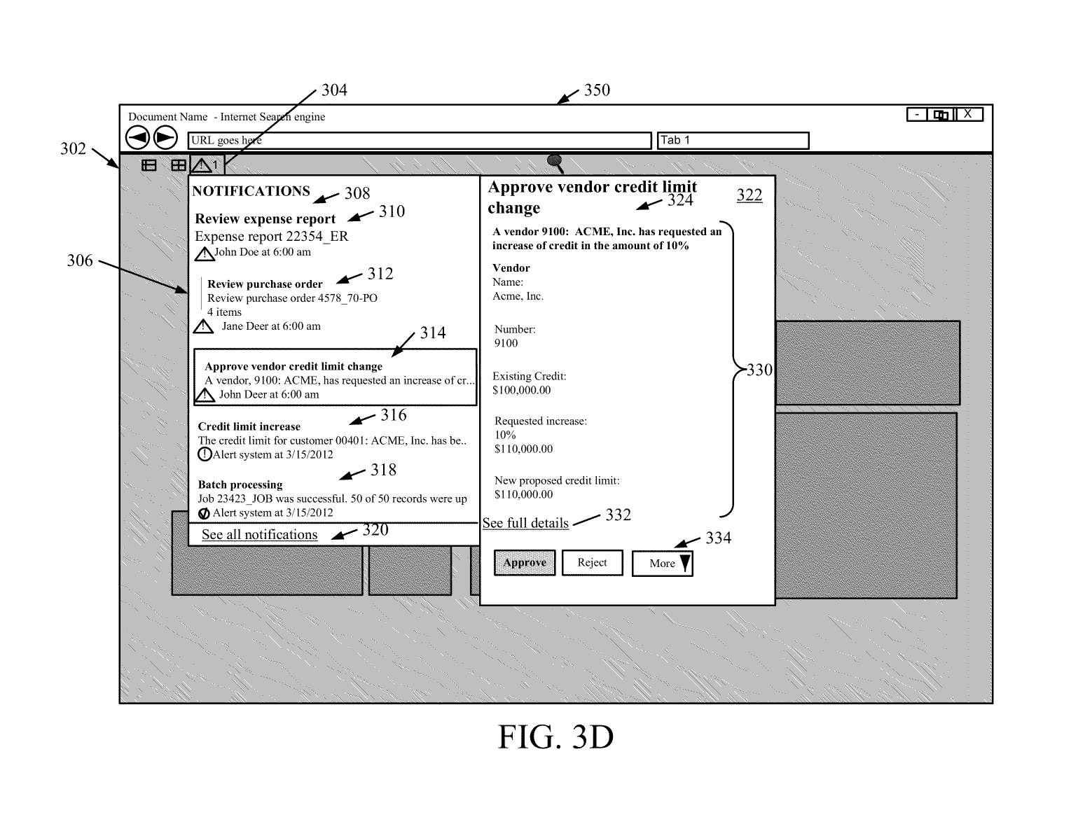

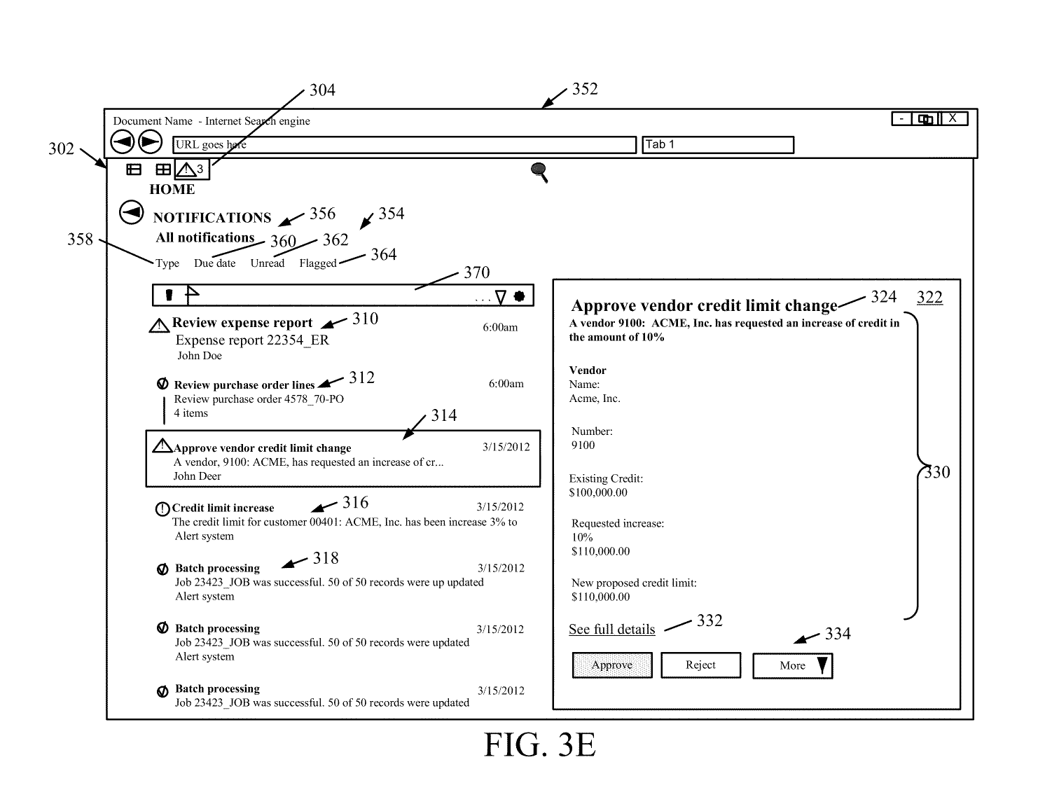

FIG. 2 is an exemplary flow diagram illustrating the operation system 100 in generating a notification display. FIGS. 3A-3E are illustrative user interface displays. FIGS. 2-3E will now be described in conjunction with one another.

It is first assumed that user 107 has logged into, or otherwise accessed, business system 100. In doing so, the user illustratively provides authentication information (such as user name and password) or other identifying information that identifies user 107, and any role in business system 100 that has been assigned to user 107. Using this information, notification system 118 can determine whether user 107 has any current notifications.

Notification system 118 receives a notification 110, 112, 114 or 116 from various different applications or components 102-108. This is indicated by block 150 in FIG. 2. Notification system 118 then aggregates the notifications on a per user. In one embodiment, notifications can be aggregated by user, and then by role (of that user). This is indicated by block 152. In order to do this, aggregation system 118 identifies the particular notification and the item that originated it. It then determines which of the users of system 100 are to receive that particular notification. It adds the newly received notification to a list or other aggregation of notifications for those users that are to receive it.

At some point, notification system 118 receives a user input from user 107 requesting to see his or her notifications. This is indicated by block 154 in FIG. 2. This can be done in a wide variety of different ways. For instance, an indicator can be displayed on a user interface display indicating that the user 107 has notifications to be viewed. Alternatively, the user can actuate a link or navigate to another page to request the notifications.

Once the user 107 has requested to view the notifications, notification system 118 uses user interface component 124 to generate a personalized display of the aggregated notifications, on a notification display, for user 107. This is indicated by block 156 in FIG. 2. The personalized display illustratively includes notifications for the specific user 107 (or for the role assigned to user 107, or for both). The notifications can include notices 158, task assignments 160, alerts 162, workflow assignments 164, and key events 166, among others. In addition, a plurality of different messages from a single source can be aggregated and shown as a single entry in the list of notifications. For instance, assume that user 107 is assigned the task (in performing his or her duties for the business) of approving requisitions. However, assume that there are also multiple different users, all of whom must approve different requisitions from different departments or from other people working for the organization, etc. In accordance with one embodiment, notification system 118 aggregates all of the requisition approvals for user 107, from the requisition system, and represents them as a single entry in the list of notifications. That entry may include, for instance, an indication that user 107 has requisitions to approve, along with a number of requisitions for which approval is needed. Aggregating messages from the same source is indicated by block 168 in FIG. 2. Of course, the notifications can include other events, messages, assignments, etc. This is indicated by block 170 in FIG. 2.

FIG. 3A shows one illustrative user interface display 200 that indicates some of the different types of notifications discussed above. User interface display 200 includes a dashboard display with a plurality of tiles 202. Each of the tiles is illustratively a link which, when actuated, navigates user 107 to underlying information (such as an entity, an activity, a task, a workflow, etc.). Each tile also illustratively has a dynamic display portion which dynamically displays data from the underlying information.

In the embodiment shown in FIG. 3A, user interface display 200 also includes an alerts and notifications tile 204. Alerts and notifications tile 204 also illustratively includes a dynamic display area 205 that displays dynamic information about the notification list corresponding to user 107.

When user 107 actuates alerts and notifications tile 204, notification system 118 retrieves all notifications for user 107 and displays them, such as on a notification display 206. It can be seen that notification display 206 includes a scrollable list 208 of notification entries 210, 212, 214, 216, 218 and 220. In one embodiment, additional notifications are entered in list 208 below notification entry 220, and they can be seen when scroll bar 222 is scrolled downward. Each notification in list 208 illustratively includes a title (shown in bold in FIG. 3A) along with a status indicator (such as indicator 226 for entry 210) as well as a time and date portion 228 that stores a time and date that the entry was placed in notification list 208 by notification system 118. Each entry can also illustratively include an optional description portion, such as portion 230 shown in entry 218. It can include multiple lines of additional text that may be helpful to user 107 in identifying the entry. In one embodiment, display 206 includes a link 224. When link 224 is actuated, notification system 118 generates a user interface display that shows a list of all notifications for user 107.

Once notifications display 206 is displayed to user 107, user 107 can illustratively provide one of a variety of different user interaction inputs on notification display 206 to interact with the display. This is indicated by block 219 in FIG. 2. By way of example, the user can provide a scroll input on scroll bar 222 to scroll the notifications display 206. This is indicated by block 250 in FIG. 2. The user can also actuate one of the entries in list 208 to see more details regarding the given entry in list 208. In response, notification system 118 illustratively generates an additional display (such as the details flyout discussed below with respect to FIGS. 3C-3E) to show more details regarding a particular entry in the list of notifications 208. Showing the details is indicated by block 253 in FIG. 2. Once the details are shown, the user can illustratively interact with the details as well, and this is indicated by block 255. This is also discussed below with respect to FIGS. 3C-3E.

User 107 can also actuate a button to see all notifications in the list. This is indicated by block 254 in FIG. 2. In addition, the user can perform certain tasks directly from the notifications display. In doing so, the user can, for example, actuate action buttons or other user input mechanisms. This is indicated by block 256. Of course, the user can interact with the notifications display 206 in other ways as well, and this is indicated by block 258.

Once the user has interacted with the notifications display 206 in one of the ways described above, or in other ways, notification system 118 illustratively takes action based on the user interaction input on the notification display. This is indicated by block 260. A number of those interactions will now be described with respect to various exemplary user interface displays. In one embodiment, display 206 includes a link 224. When link 224 is actuated, notification system 118 generates a user interface display that shows a list of all notifications to user 107.

Entry 216 shows one embodiment where multiple notifications from a single source have been aggregated. It is possible that, when each item from every source of notifications is individually listed in display 206, it may be overwhelming to user 107. Therefore, in some embodiments, the notifications from each source of notifications are aggregated in a summary form. Entry 216, for instance, is an entry showing notifications received from the general ledger posting application (or component) in business system 100. Instead of listing all notifications from that component, entry 216 simply includes a line 232 which identifies the number of notifications from the general ledger posting component. When the user actuates entry 216, the user is illustratively navigated to a more detailed display showing the two notifications.

All of the entries 210, 212, 214, 216 and 218 are illustratively user actuatable links. When the user actuates the entry, the user is illustratively navigated to a detail screen or display which shows more detail about the given entry. This is described in greater detail below with respect to FIGS. 3C-3E.

FIG. 3B shows another embodiment of user interface display 200. Similar items to those shown in FIG. 3A are similarly numbered in FIG. 3B. However, it can be seen in FIG. 3B that notifications display 206 has been scrolled downward. Scroll bar 222 has been moved downward to fully reveal entry 220 in notifications list 208.

Entry 220 is illustratively a notification that represents a task assigned to user 107. The task is to review and either approve or reject an expense report. Thus, entry 220 includes a link 236 to the underlying document (or entity)—that comprises the expense report. When the user actuates link 236, the user is illustratively navigated to a full display of the line items in the expense report. Entry 220 also illustratively includes a task assignor display 238. This indicates a person who assigned this task to user 107. Further, entry 220 includes a date and time indicator 240 that shows a date and time when the task was assigned. Entry 220 also illustratively includes a plurality of action buttons 234. The action buttons 234 allow user 107 to take action with respect to this notification, directly from notifications display 206. Since the task corresponding to entry 220 is to review an expense report, buttons 234 illustratively include an “approve” button, a “reject” button, and a “more” button. User 107 can thus illustratively actuate link 236 to review the detailed line items in the expense report and then actuate one of buttons 234 to take action with respect to this notification (e.g., approve it, reject it, or see more information about it), all directly from notifications display 206.

FIG. 3C shows another embodiment of a user interface display 300. It can be seen that user interface display 300 includes an application bar shown generally at 302. The application bar 302 illustratively includes a notification element 304 that displays a number of notifications currently pending for user 107. When the user actuates notification element 304, notification system 118 illustratively generates notification display 306. It can be seen that notification display 306 (like notification display 206 shown in the above figures) illustratively includes a list 308 of entries 310, 312, 314, 316 and 318).

FIG. 3C also shows, however, that when the user selects one of the entries in list 308, notification system 118 generates a details flyout display 322 that provides additional details regarding that particular entry. For instance, as shown in FIG. 3C, the user has selected entry 310 in list 208. Notification system 118 thus generates details flyout display 322 that displays additional details regarding entry 310.

In the particular embodiment shown in FIG. 3C, entry 310 corresponds to a notification entry for reviewing an expense report. Therefore, detail flyout 322 illustratively includes a title section 324 that provides a title of the notification. In addition, a source document link (or entity link) 326 can be actuated by user 107 to navigate to the underlying document or entity. Common action section 328 describes any common actions that are to be taken with respect to this notification. Detail flyout 322 also illustratively includes a summary portion 330 that summarizes the information in entry 310. Detail flyout 322 also illustratively includes a full details actuator 332. When user 107 actuates actuator 322, user 107 is illustratively navigated to a full details display regarding the entry 310. In the embodiment being shown in FIG. 3C, the user may illustratively be navigated to a full line item detail display view of the subject expense report.

Detail flyout 322 also illustratively includes action buttons that allow the user to take action (or perform a task) with respect to entry 310, directly from detail flyout display 322. Since entry 310 has to do with reviewing and either approving or rejecting an expense report, buttons 334 illustratively include an “approve” button, a “reject” button, and a “more” button. If the user actuates the approve button, the user can illustratively approve the expense report directly from flyout display 322. The user can also reject the expense report by actuating the reject button, and view more details about the expense report by actuating the more button.

Entry 312 in notifications display 308 also corresponds to a task which involves reviewing a purchase order. It may be, for example, that user 107 only needs to review certain line items out of each purchase order (or out of specified purchase orders). By way of example, it may be that user 107 is charged with the task of approving the purchases of certain items. Therefore, a given purchase order may have multiple different line items that must be individually approved by user 107. However, it may be that displaying all of the individual line items (even though they all require separate approval by user 107) may overwhelm the notifications display 308 and make it confusing or difficult to read.

Thus, in one embodiment, notifications system 118 aggregates all notification corresponding to a single source document (or even a source application or system that generates the notifications), and displays an aggregated display on notification display 308. In the embodiment described in FIG. 3C, entry 312 has an aggregated display element 335. Display element 335 shows that entry 312 corresponds to the tasks of reviewing and approval of line items in a purchase order. However, instead of listing each of the line items that must be approved by user 107, entry 312 simply indicates that there are four line items that must be approved. It this way, the user can select entry 312 and notification system 118 generates a detail flyout that shows all four of the line items (or even a subset of the line items) along with a set of actions buttons. User 107 can thus review each line item on the flyout and either approve or reject the line items. This allows a user to quickly take action with respect to those line items, without overwhelming the notifications display 308.

FIG. 3D shows another embodiment of a user interface display 350. User interface display 350 is similar to user interface display 300 shown in FIG. 3C, and similar items are similarly numbered. However, it can be seen that in FIG. 3D, the user has selected the “approve vendor credit limit change” entry 314 in list 308 in notification display 306. This causes notification system 118 to generate a detail flyout 322 corresponding to entry 314. This illustrates that, as the user selects various different entries in list 308, the detail flyout 322 will change as well, in order to show more detailed information about the selected entry.

FIG. 3E shows yet another user interface display 352. User interface display 352 is similar to user interface display 350 shown in FIG. 3D, and similar items are similarly numbered. However, it can be seen in FIG. 3E that the user has not only selected the approve vendor credit limit entry 314 (and thus detail flyout 322 displays details with respect to entry 314) but the user has also actuated the see all notifications button 320 shown in FIG. 3D. This causes the notifications display 308 (in FIG. 3D) to be modified to show a complete listing 354 of all notifications for user 107.

In addition, listing 304 includes a set of filter buttons 356. Filter buttons 356 allow user 107 to filter listing 354 based on various criteria. For instance, buttons 356 include a type button 358 that allows the user 107 to filter notifications based on the type of notification. It includes a due date button 360 that allows user 107 to filter the notifications based on their due date. It includes an unread button 362 that allows user 107 to filter based on the notifications that are unread. It also includes a flagged button 364 that allows user 107 to filter the displayed notifications in listing 354 based on those that are flagged as urgent or flagged for another reason.

Listing 354 also illustratively includes a search box 370. Search box 370 illustratively allows user 107 to enter keyword search terms to search the listing 354 of entries based on keywords.

It can thus be seen that notification system 118 aggregates notifications from various components, subsystems, applications, etc., and generates a notification display for a given user. The user can see additional details about each notification and can also perform tasks directly from the notification display. This significantly enhances the ability of a user 107 to view all notifications from system 100 that are intended for user 107, and to even take action to perform tasks or to address items in any given notification.

It should also be noted that various items in the notification display can be individually configured either by a user, or for a user. For instance, if a user wishes to have certain fields from an underlying document or entity in the summary section of detail flyout 322, those items can be added. Further, if the user wishes to have certain action buttons or other links in the detail flyout, those items can be added as well.

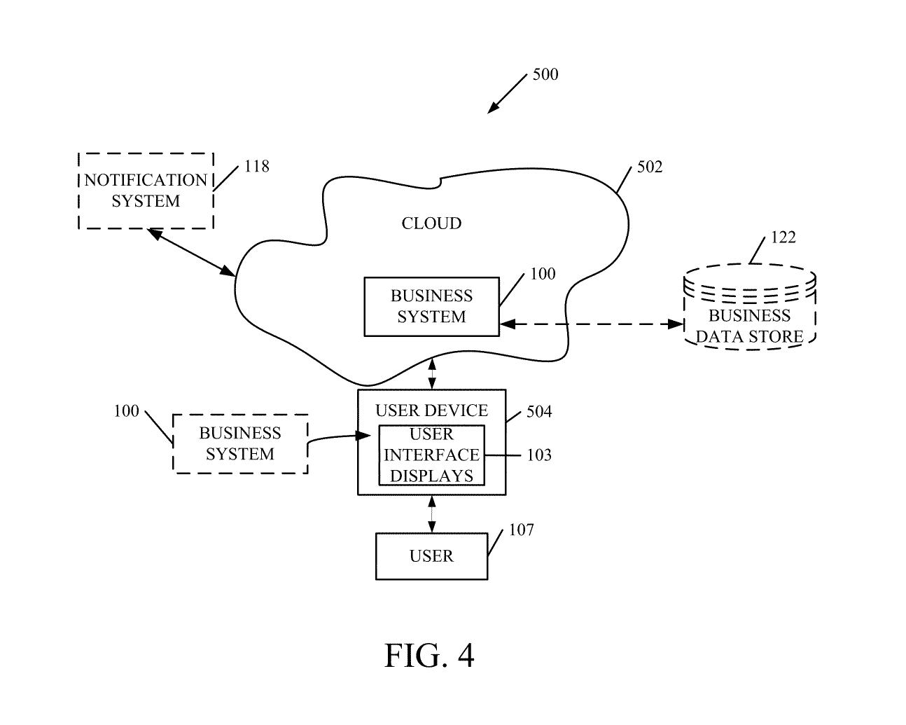

FIG. 4 is a block diagram of business system 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of system 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 4, some items are similar to those shown in FIG. 1 and they are similarly numbered. FIG. 4 specifically shows that business system 100 is located in cloud 502 (which can be public, private, or a combination where portions are public while others are private). Therefore, user 107 uses a user device 504 to access those systems through cloud 502.

FIG. 4 also depicts another embodiment of a cloud architecture. FIG. 4 shows that it is also contemplated that some elements of business system 100 are disposed in cloud 502 while others are not. By way of example, data store 122 can be disposed outside of cloud 502, and accessed through cloud 502. In another embodiment, notification system 118 is also outside of cloud 502. System 100 (or part of it) can also reside on user device 504. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that system 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

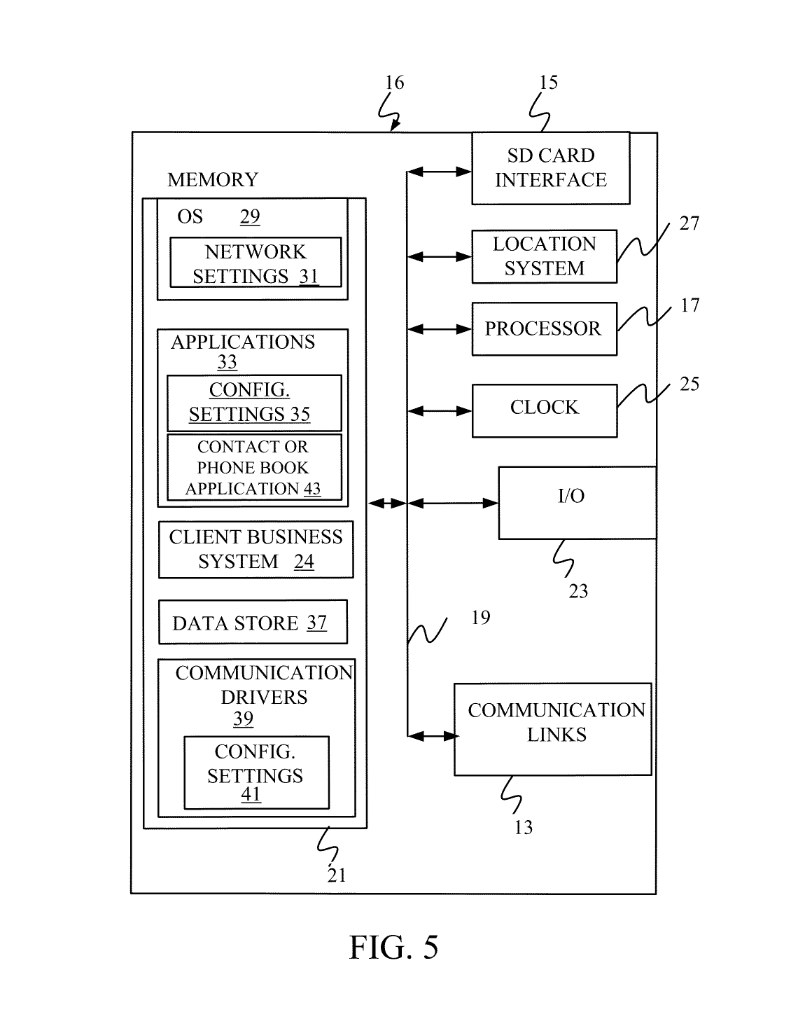

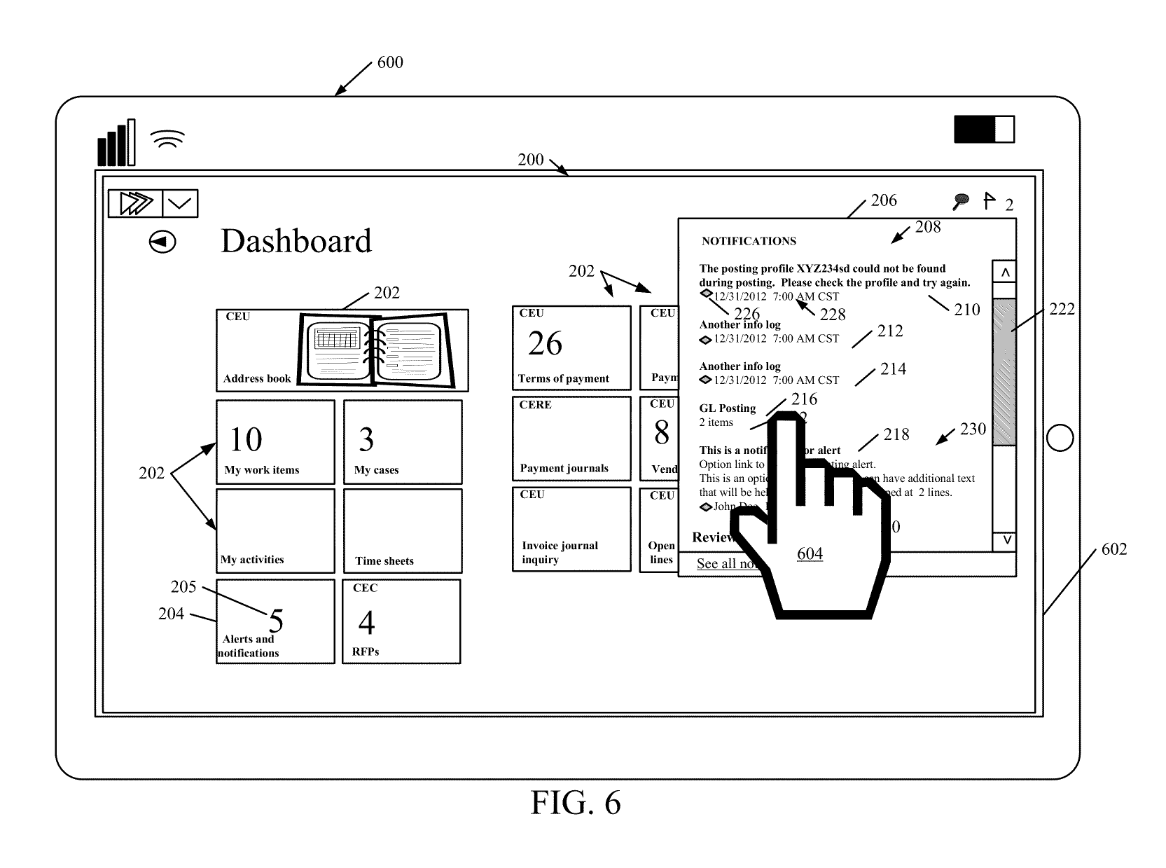

FIG. 5 is a simplified block diagram of one illustrative embodiment of a handheld or mobile computing device that can be used as a user's or client's hand held device 16, in which the present system (or parts of it) can be deployed. FIGS. 6-10 are examples of handheld or mobile devices.

FIG. 5 provides a general block diagram of the components of a client device 16 that can run components of system 100 or that interacts with system 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 (which can also embody processor 120 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. The items in data store 122, for example, can reside in memory 21. Similarly, device 16 can have a client business system 24 which can run various business applications or embody parts or all of system 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 6 shows one embodiment in which device 16 is a tablet computer 600. In FIG. 6, computer 600 is shown with user interface display 200 (From FIG. 3A) displayed on the display screen 602. Screen 602 can be a touch screen (so touch gestures from a user's finger 604 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

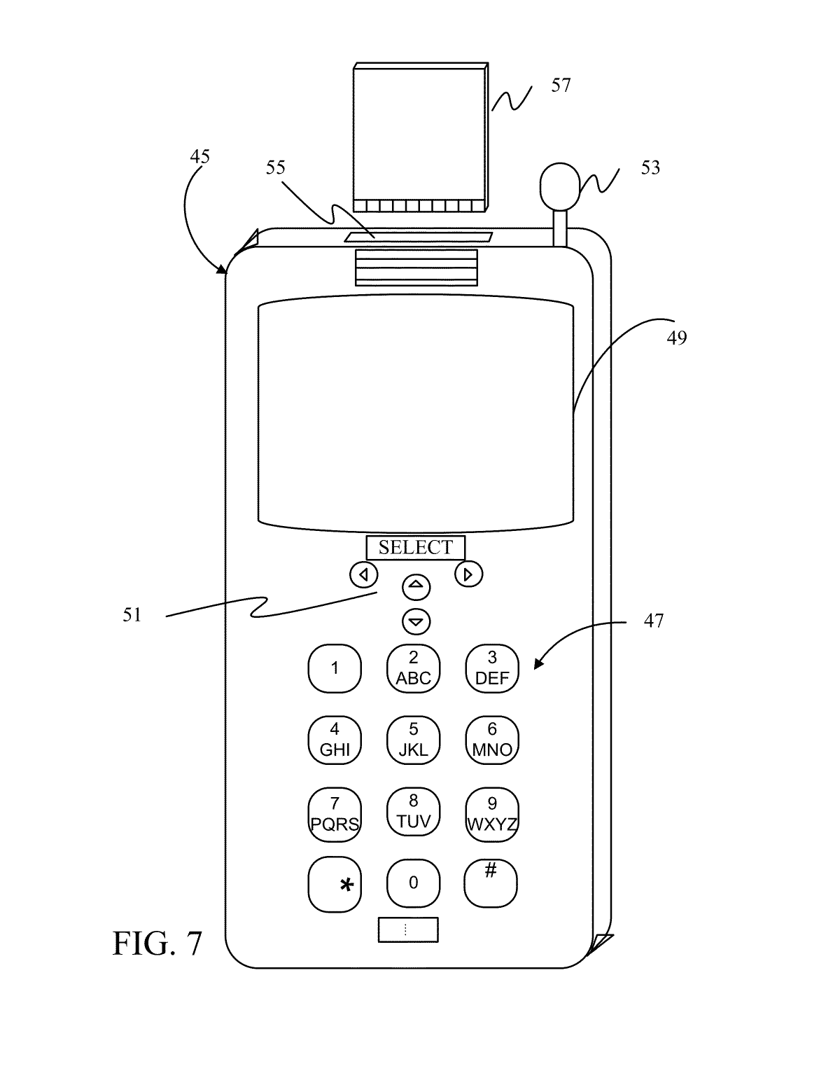

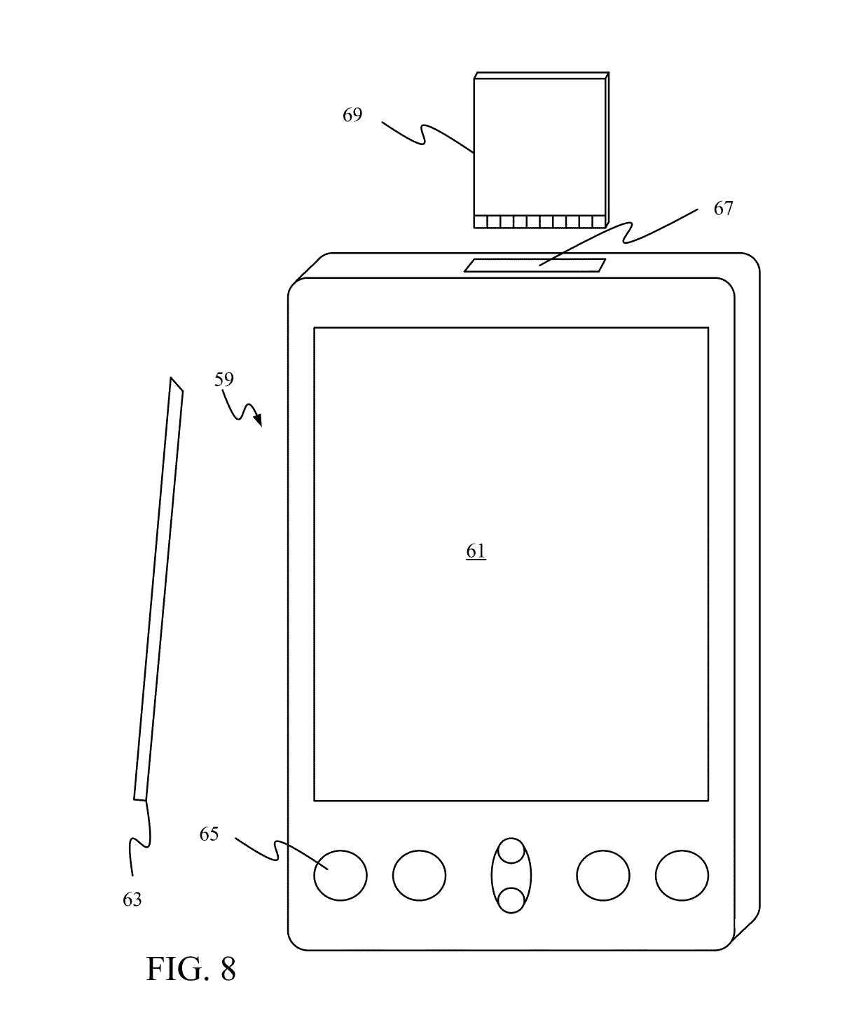

FIGS. 7 and 8 provide additional examples of devices 16 that can be used, although others can be used as well. In FIG. 7, a feature phone, smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 8 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

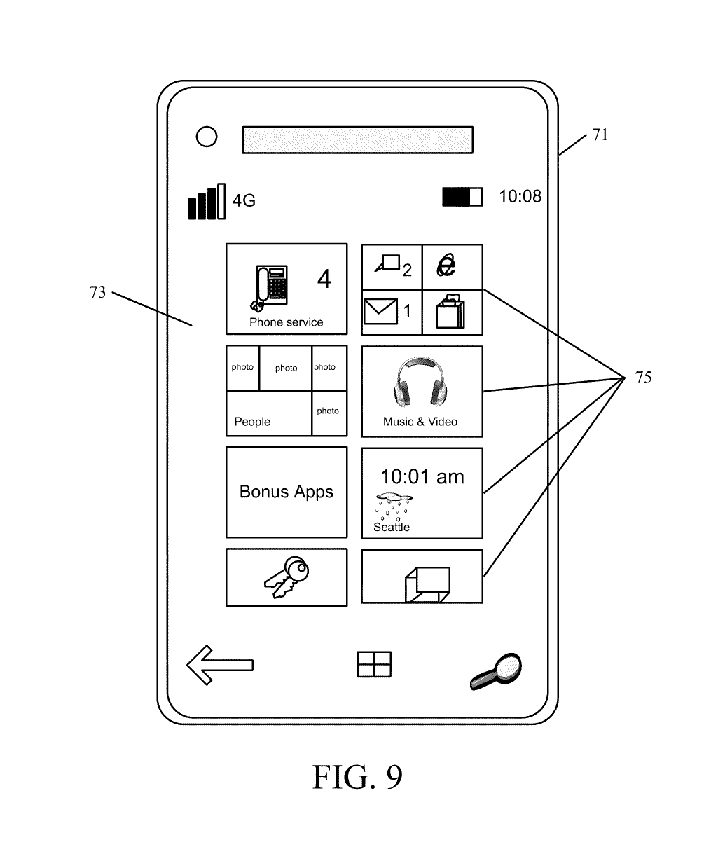

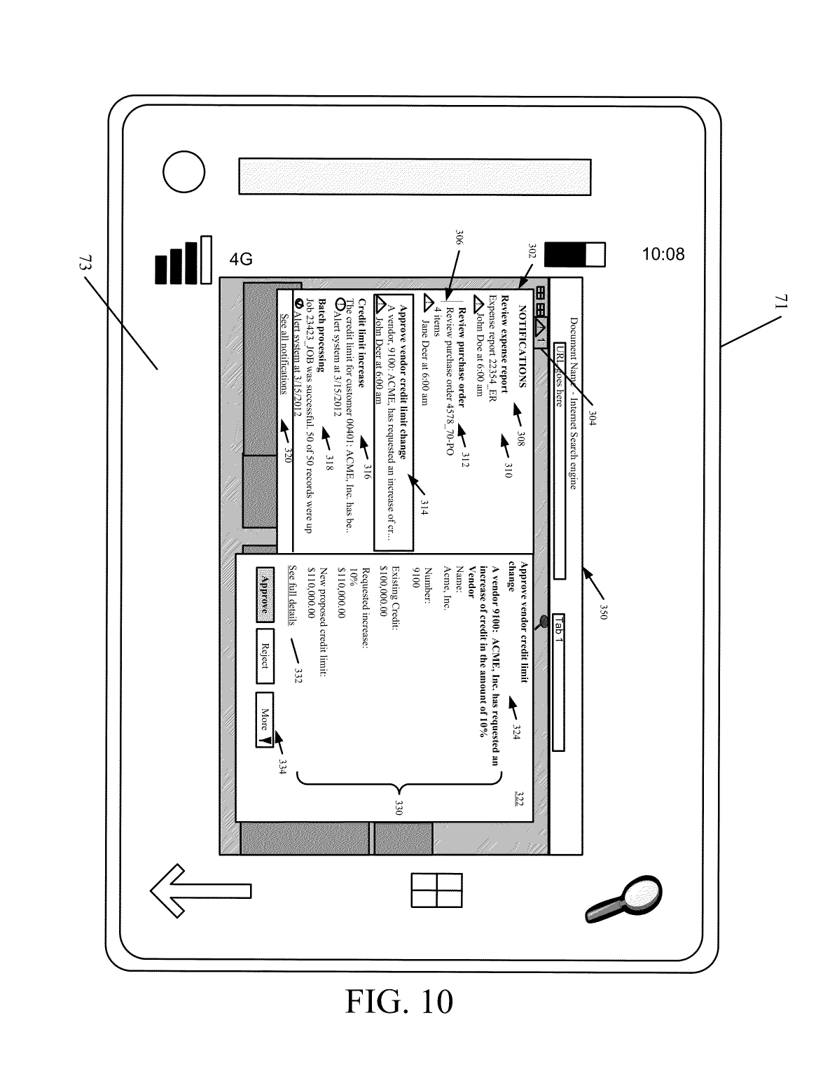

FIG. 9 is similar to FIG. 7 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone. FIG. 10 shows smart phone 71 with the display of FIG. 3D on it.

Note that other forms of the devices 16 are possible.

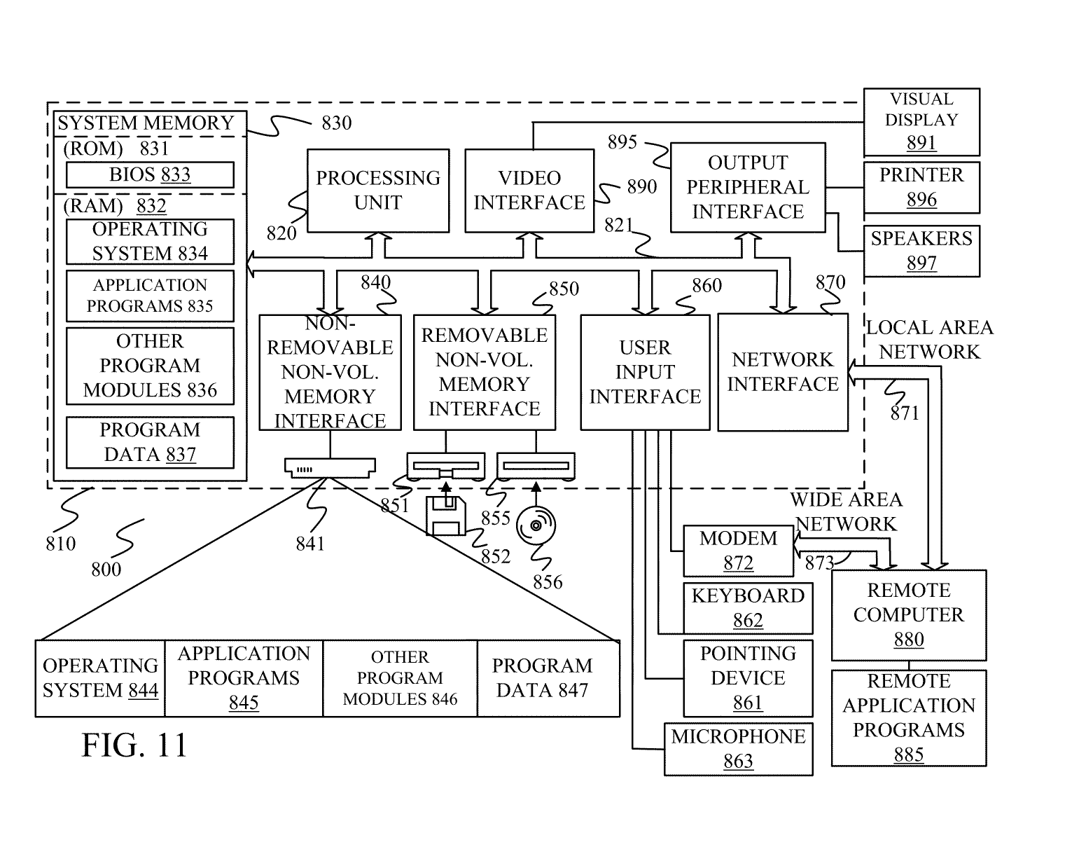

FIG. 11 is one embodiment of a computing environment in which system 100, or parts of it, (for example) can be deployed. With reference to FIG. 11, an exemplary system for implementing some embodiments includes a general-purpose computing device in the form of a computer 810. Components of computer 810 may include, but are not limited to, a processing unit 820 (which can comprise processor 120), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 11.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 11 illustrates operating system 834, application programs 835, other program modules 836, and program data 837.

The computer 810 may also include other removable/non-removable volatile/nonvolatile computer storage media. By way of example only, FIG. 11 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 11, provide storage of computer readable instructions, data structures, program modules and other data for the computer 810. In FIG. 11, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 11 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 11 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method, comprising:
receiving a user request input, on a user interface display, requesting display of notifications;
displaying a user-specific list of notification entries, each notification entry representing a notification, the notification entries representing notifications from a plurality of different components of a computer system.

2. The computer-implemented method of claim 1 wherein the computer system comprises a business system and wherein the components of the computer system comprise business components of the business system, and further comprising:
receiving the notifications from the plurality of different business components of the business system at a notification system; and
aggregating the notifications into groups of user-specific notifications to generate the user specific list of notifications.

3. The computer-implemented method of claim 2 and further comprising:
receiving a plurality of different notifications for a given user from a single business component of the business system; and
aggregating the plurality of different notifications from the single business component into a single notification entry in a list of notification entries for the given user.

4. The computer-implemented method of claim 3 wherein the single business component comprises a single entity or a single document in the business system.

5. The computer-implemented method of claim 2 wherein displaying the list of user specific notification entries comprises:
receiving user actuation of a details user input mechanism corresponding to a given notification entry; and
displaying a details display showing details of the notification corresponding to the given notification entry.

6. The computer-implemented method of claim 5 wherein displaying the details display comprises:
displaying a details fly-out display showing the details, along with a task actuator, actuatable to perform a task relative to the notification corresponding to the given notification entry, from the details fly-out display.

7. The computer-implemented method of claim 2 wherein displaying the user-specific list of notification entries comprises:
displaying a task actuator corresponding to a given notification entry, actuatable to perform a task relative to a notification corresponding to the given notification entry from the notification list.

8. The computer-implemented method of claim 2 wherein displaying the user specific list of notification entries comprises:
displaying a component identifier corresponding to a given notification entry, the component identifier identifying a business component that generated a notification corresponding to the given notification entry.

9. The computer-implemented method of claim 2 wherein displaying the user specific list of notification entries comprises:
displaying a see all actuator, actuatable by a user to display a list of all notification entries for the user.

10. The computer-implemented method of claim 9 wherein list of all notification entries includes a filter user input mechanism, and further comprising:
receiving actuation of the filter user input mechanism; and
filtering the displayed list of all notification entries based one or more filter criteria corresponding to the filter user input mechanism.

11. The computer-implemented method of claim 2 wherein displaying the user specific list of notification entries comprises:
displaying a link corresponding to a given notification entry that links to a source document to which the given notification entry pertains.

12. The computer-implemented method of claim 1 wherein displaying the user-specific list comprises:
obtaining a role corresponding to a given user; and
displaying a list of notification entries corresponding to the role.

13. A computer system, comprising:
a plurality of different components each generating notifications;
a notification system receiving the notifications from the plurality of different components and generating a user-specific list of notification entries, each notification entry representing a corresponding notification, the notification system receiving a request from a given user and displaying a user-specific list of notification entries for the given user; and
a computer processor being a functional part of the system and activated by the components and the notification system to facilitate generating the notifications and generating the user-specific list of notification entries.

14. The computer system of claim 13 wherein the computer system comprises a business system and wherein the plurality of different components comprise a plurality of different business components of the business system.

15. The computer system of claim 14 wherein the notification system aggregates messages for the given user, from a single component, into a single entry in the list of notification entries.

16. The computer system of claim 14 wherein the notification system displays a given notification entry with task input mechanisms actuatable to perform a task relative to a notification corresponding to the given notification entry, from the list of notification entries.

17. The computer system of claim 14 wherein each notification entry is actuatable to display a detail display showing details of the corresponding notification.

18. A computer readable storage medium storing computer executable instructions, executable by a computer to perform a computer-implemented method comprising:
receiving a user request input, on a user interface display, requesting display of notifications;
displaying a user-specific list of notification entries, each notification entry representing a corresponding notification, the notification entries representing notifications from a plurality of different components of a computer system and having links to more detailed information about the corresponding notification.

19. The computer readable medium of claim 18 wherein the computer system comprises a business system and wherein the components of the computer system comprise business components of the business system, and further comprising:
receiving the notifications from the plurality of different business components of the business system at a notification system;
aggregating the notifications into groups of user-specific notifications to generate the user specific list of notifications.

20. The computer readable medium of claim 19 and further comprising:
receiving user actuation of a link;
displaying a details fly-out display showing the more detailed information, along with a task actuator, actuatable to perform a task relative to the notification corresponding to the given notification entry, from the details fly-out display.
